(19) United States
(12) Patent Application Publication
(10) Pub. No.: US 2026/0256274 A1
(43) Pub. Date: Sep. 3, 2026

(54) BRUSH, METHOD FOR MANUFACTURING BRUSHES AND BRUSH-MANUFACTURING DEVICE

(71) Applicant: Zahoransky AG, Todtnau (DE)

(72) Inventors: Marc KÖNIG, Wittnau (DE); Ingo KUMPF, Schlechtnau (DE); Florian KIEFER, Fröhnd (DE)

(73) Assignee: Zahoransky AG, Todtnau (DE)

(21) Appl. No.: 18/863,052

(22) PCT Filed: Feb. 23, 2023
(86) PCT No.: PCT/EP2023/054533

§ 371 Date: Nov. 5, 2024

(30) Foreign Application Priority Data
May 20, 2022 (EP) 22174316.4

(51) Int. Cl. A46B 9/04; A46B 3/06; A46D 1/00; A46D 3/04; A46D 3/08

(52) U.S. Cl. CPC A46B 9/04; A46B 3/06; A46D 1/0207; A46D 3/045; A46D 3/087; A46B 2200/01

(57) ABSTRACT

A brush and method of brush production in which, inter alia, a brush (1) which has a bristle carrier (2) with a receiving depression (5) which, during fastening of bristle filaments (4) to the bristle carrier (2), is filled completely or partially by melted filament material of fastening-side ends (6) of the bristle filaments (4) of the brush (1) to be produced.

### CROSS-REFERENCE TO RELATED APPLICATIONS

The present application is a 371 National Phase of PCT/EP2023/054533, filed Feb. 23, 2023, which claims priority from European Patent Application No. 22174316.4, filed May 19, 2022, both of which are incorporated herein by reference as if fully set forth.

### TECHNICAL FIELD

The invention relates to a brush, in particular a toothbrush, with a bristle carrier and a bristle set which is fastened to the bristle carrier, to a method for producing a brush of this type, and to a brush production apparatus for producing brushes of this type.

### BACKGROUND

For the use, in particular, of a toothbrush, it can be advantageous if the bristle carrier, in particular a brush head, of the toothbrush is of as compact a design as possible. A compact brush head is as a rule perceived to be more pleasant in the oral cavity of a person using the toothbrush than larger brush heads.

A brush head can be perceived to be compact, for example, when the brush head has as small a lateral overhang as possible with respect to the bristle set and, moreover, has as low a volume as possible in relation to a volume of the bristle set. It is desirable that a total volume which is occupied by the bristle set and the brush head predominantly consists of the volume of the bristle set and therefore of the volume of the constituent parts of the brush which have a cleaning action.

Therefore, in this context, edge spacings of the bristle set from a peripheral edge of the bristle carrier, in particular of the brush head, which are as small as possible are also desirable. It is therefore an aim of the invention to provide a brush, in particular a toothbrush, with a brush head which is as compact as possible and, when cleaning movements are carried out with the use-side end of the brush, for example in an oral cavity, is perceived as only slightly annoying for a person using the brush.

Even in the case of different brushes, however, it can be advantageous for their use properties for the bristle carrier to be of compact design, for example, as a result of small edge spacings of the bristle set from a peripheral edge of the bristle carrier.

Furthermore, environmental protection and the possibility of recycling play an increasing role in the case of brushes. In this context, it is desirable for brushes to be provided which can be recycled comparatively simply. The economical manufacture of the brushes is also significant.

### SUMMARY

It is therefore an object of the invention to provide a brush with improved use properties and production properties, and a method for producing a brush of this type, and a corresponding brush production apparatus.

In order to achieve this object, first of all a brush with one or more of the features disclosed herein which are directed to a brush is proposed. Therefore, in order to achieve the object, a brush, for example a toothbrush, with a bristle carrier and a bristle set of bristle filaments is proposed, in particular, wherein the bristle carrier has at least one receiving depression, in which the bristle filaments are fastened by way of their fastening-side ends, and wherein the receiving depression is filled completely or partially by filament material, melted to fasten the bristle filaments, of the fastening-side ends. When, in particular, the brush is configured as a toothbrush, the bristle carrier, to which the bristle set of bristle filaments is fastened, can be a brush head of the brush.

By virtue of the fact that the melted filament material of the fastening-side ends of the bristle filaments fills the receiving depression in the bristle carrier completely or at least partially, the bristle carrier can have a comparatively delicate design before fastening of the bristle filaments in the receiving depression. In this way, a brush is provided, the bristle carrier of which has as compact a design as possible and can have only a comparatively small edge-side oversize with respect to the bristle set on the bristle carrier.

If the receiving depression is partially filled, it can be advantageous if the receiving depression is predominantly filled with the melted filament material.

A particularly stable and at the same time compact bristle carrier is produced if the receiving depression is filled completely by the melted filament material of the fastening-side ends of the bristle filaments.

In the case of the brush according to the invention, the fastening of the bristle filaments to the bristle carrier can take place by way of an interaction between the filament material and the material of the bristle carrier. In the case of the brush according to the invention, a separate fastening means such as, for example, anchors which require a certain minimum material thickness of the bristle carrier in order to fasten the bristle filaments can be dispensed with.

It is provided in one embodiment of the invention that, before fastening of the bristle filaments, the bristle carrier has its smallest material thickness in the region of the receiving depression. In particular, before fastening of the bristle filaments, the bristle carrier can have its smallest material thickness (which can be measured in the direction of a perpendicular with respect to the receiving depression) in the region of the receiving depression. For the purpose of minimizing the volume of the bristle carrier, the receiving depression in the bristle carrier can therefore be a region, in which there is initially as little material as possible. This region can therefore initially be a mechanical weak point of the brush. By the receiving depression being filled with the melted filament material, this weak point is compensated for on the finished brush, however, after fastening of the bristle filaments.

It is thus possible that the bristle carrier is reinforced and, in particular, completed by the melted material. The melted filament material therefore becomes part of the bristle carrier after it has solidified within the receiving depression. This makes the desired delicate and compact design of the bristle carrier possible.

At least one reinforcing rib can be configured within the receiving depression. The reinforcing rib can run within the receiving depression and/or through the receiving depression of the bristle carrier. Here, the at least one reinforcing rib can be at a certain distance from the edge of the bristle carrier or else can be connected to the edge of the bristle carrier. The at least one reinforcing rib can increase the mechanical stability of the bristle carrier before fastening of the bristle filaments to the bristle carrier. This can simplify the handling of the bristle carrier during the production of the brush.

The melted filament material of the fastening-side ends of the bristle filaments can form a carrier plate which fills the receiving depression after fastening of the bristle filaments to the bristle carrier. It is possible that, after fastening of the bristle filaments to the bristle carrier, a surface of the carrier plate is flush with respect to a brush surface, adjoining the receiving depression and the bristle set, of the brush, in particular of the bristle carrier. In this way, a stepless transition is produced between a front side of the carrier plate made from melted filament material, on which the bristle filaments are arranged, and a brush surface which surrounds the closed receiving depression and the bristle set. A stepless transition of this type can counteract an accumulation of impurities and an associated contamination of the brush. This is of particular significance, in particular, in the case of toothbrushes.

It can be advantageous for the production of the brush if the bristle filaments and the bristle carrier comprise, at least in the region of the receiving depression, materials which are compatible for an integrally joined connection or the same material which is suitable for an integrally joined connection. In this way, a reliable and durable integrally joined connection can be produced between the bristle filaments and the bristle carrier of the brush, in the case of which connections separate fastening means for the bristle filaments such as, for example, anchors can be dispensed with.

When, in particular, the bristle filaments and the bristle carrier comprise the same material, what is known as a single substance brush can thus be provided which can be recycled particularly simply. A brush of this type does not have to be disassembled into its different constituent parts during recycling.

The bristle filaments, which are fastened in the receiving depression, and the bristle carrier can form a materially homogeneous, monolithic unit. The bristle filaments and the bristle carrier can be connected to one another in an integrally joined manner. In this way, separate means for fastening the bristle filaments to the bristle carrier can be dispensed with. This can simplify the production, but also the recycling of brushes of this type.

The bristle filaments and the bristle carrier can comprise, at least in the region of the receiving depression, plastic, for example biodegradable plastic, in particular polyamide, preferably PA 10.10 or PA 12. When, in particular, the bristle carrier and the bristle filaments comprise biodegradable plastic, a brush is provided which is particularly environmentally friendly and can be recycled particularly simply.

The bristle carrier can have an edge which delimits the receiving depression. This edge can be a boundary of the receiving depression and can guide the melted filament material of the fastening-side ends of the bristle filaments during the connection of the bristle filaments to the bristle carrier, in such a way that complete filling of the receiving depression takes place reliably during the connection of the bristle filaments to the bristle carrier.

If at least one recess which is filled completely or partially by the melted filament material, preferably in a flush manner with respect to adjacent edge portions, is configured in the edge, the bristle set can be fastened to the bristle carrier at least in the region of this at least one recess at a particularly small edge spacing from a periphery, that is to say a peripheral surface, of the bristle carrier.

In the case of toothbrushes, in particular, as small an edge spacing as possible is favorable for the use of the toothbrush. Contact of the bristle carrier with the gums of a person using the toothbrush can be minimized by the small edge spacing. The brush can have a compact design as a result of the small edge spacing of the bristle set from the periphery of the bristle carrier. The use of a brush of this type is as a rule perceived as more pleasant than the use of a brush with a bristle carrier, in particular a brush head, which has a greater volume.

In order to achieve the object, a method for producing a brush of this type is also proposed, which method has one or more of the features disclosed herein directed to a method for producing a brush.

In the case of the method, it is provided according to the invention that the fastening-side ends of the bristle filaments are heated in order to connect the bristle filaments to the bristle carrier, and the receiving depression is filled completely or partially by filament material, melted in the process, of the fastening-side ends of the bristle filaments during fastening of the bristle filaments to the bristle carrier.

A particularly stable and compact bristle carrier is produced if the receiving depression is filled completely with the melted filament material. In the case of partial filling of the receiving depression, it can be advantageous for the stability of the bristle carrier if the receiving depression is predominantly filled with the melted filament material.

Here, the bristle filaments can be connected to the bristle carrier in an integrally joined manner in the receiving depression. The bristle carrier can be completed and reinforced by the fastening of the bristle filaments in the receiving depression as a result of the receiving depression being filled.

It is provided in one embodiment of the method that the fastening-side ends of the bristle filaments and the bristle carrier are heated in the region of the receiving depression.

The bristle filaments and the bristle carrier can be connected to one another in an integrally joined manner during the fastening of the bristle filaments in the receiving depression. It can be sufficient for this purpose if the fastening-side ends of the bristle filaments are heated to a higher temperature than the bristle carrier in the region of the receiving depression. The fastening-side ends of the bristle filaments are preferably heated to a temperature, at which the fastening-side ends of the bristle filaments melt. Here, the fastening-side ends of the bristle bundle can be combined to form at least one carrier plate.

The bristle carrier does not necessarily have to be heated to a comparatively high temperature. Rather, it can be sufficient if the bristle carrier is heated to a temperature at which it softens but does not melt. This can be sufficient for a reliable connection of the bristle filaments to the bristle carrier in the region of the receiving depression. If the bristle carrier is heated to a less pronounced extent than the bristle filaments, the bristle carrier can cool more rapidly. This can lead to a shorter process time during the production of the brush and can increase the economic efficiency of the method.

If the brush, in particular the bristle carrier, has an edge which laterally delimits the receiving depression, and there is at least one recess in this edge, this recess can be filled completely or partially by the filament material of the fastening-side ends, preferably in a flush manner with respect to adjacent edge portions. The bristle set can thus assume as small an edge spacing as possible from a periphery of the bristle carrier, and an offset-free periphery can additionally be formed. An offset-free periphery can facilitate the handling of the brush, in particular if it is configured as a toothbrush, and can additionally counteract adhesion of impurities and contamination of the brush.

In order to fasten the bristle filaments in the receiving depression, the bristle carrier can be inserted into a mold. The mold can have a mold wall which surrounds the receiving depression of the bristle carrier laterally at least in sections. The mold can surround the bristle carrier in such a way that an edge of the bristle carrier which delimits the receiving depression transversely with respect to a longitudinal extent direction of the bristle filaments on the brush is laterally supported. The mold can therefore contribute to the melted filament material of the bristle filaments during the connection of the bristle filaments to the bristle carrier being guided in such a way that the receiving depression is reliably filled completely or partially during the connection of the bristle filaments to the bristle carrier and a lateral discharge of the melted filament material can be prevented.

After filling of the receiving depression by the filament material of the fastening-side ends, the bristle carrier can be cooled. This can take place, for example, by way of heat conduction via the mold and/or a cooling apparatus of a brush production apparatus which will be explained in even greater detail in the following text.

In order to achieve the object, a brush production apparatus for producing brushes as described above is proposed which has one or more of the features disclosed herein directed to a brush production apparatus of this type. Here, the brush production apparatus can be configured to carry out the method for producing a brush as disclosed herein.

In the case of the brush production apparatus, it is in particular therefore proposed to achieve the object that the brush production apparatus has a heating apparatus which comprises two heating surfaces, of which a first heating surface is provided to heat fastening-side ends of bristle filaments and a second heating surface is provided to heat a bristle carrier in a region of its receiving depression.

The heating surfaces can be configured to emit heat radiation, in order to heat the bristle filaments and the bristle carrier in a contactless manner.

The heating apparatus is preferably configured to heat the heating surfaces to different temperatures. The heating apparatus can be configured to heat the first heating surface to a temperature which is sufficient to melt fastening-side ends of bristle filaments.

It is possible, furthermore, that the two heating surfaces are arranged on a common heating element, in particular on different sides of the heating element, for example on sides of the heating element which face away from one another.

Before the connection of the bristle filaments to the bristle carrier, the heating element can be arranged in an intermediate space between the provided bristle filaments and the bristle carrier, in order to heat the bristle filaments and the bristle carrier. As a result of the heating of the fastening-side ends of the bristle filaments, they can melt. After heating of firstly the bristle filaments and secondly the bristle carrier, the heating element can be removed and the bristle filaments can be introduced with their fastening-side ends into the receiving depression of the bristle carrier. Here, the receiving depression can be filled completely or partially with the melted filament material of the fastening-side ends of the bristle filaments, in order to complete and to reinforce the bristle carrier and to fasten the bristle filaments to the bristle carrier.

The heating apparatus can be configured to control the temperatures of the two heating surfaces. In order to control the temperatures, the heating apparatus can have a corresponding control unit. In order to detect the temperature of at least one of the two heating surfaces and in order to control the temperature, the heating apparatus can have at least one temperature sensor. Each heating surface of the heating apparatus is preferably assigned at least one temperature sensor. This facilitates temperature control of the heating surfaces which is as precise as possible when the method is carried out on the brush production apparatus.

Furthermore, the brush production apparatus can have a mold for receiving and supporting the bristle carrier. The bristle carrier can be inserted into this mold for the connection of the bristle filaments to the bristle carrier. The bristle carrier can already be arranged in this mold when the bristle carrier is heated in the region of its receiving depression by way of the heating apparatus of the brush production apparatus.

As has already been explained in conjunction with the method for producing a brush, the mold can facilitate a targeted distribution of the melted filament material of the fastening-side ends of the bristle filaments within the receiving depression. The mold can therefore contribute to the receiving depression in the bristle carrier being reliably filled completely or partially during the fastening of the bristle filaments.

Furthermore, the brush production apparatus can have a profiling apparatus for profiling a bristle set of a brush to be produced. With the aid of the profiling apparatus, it is possible for, in particular, cleaning-side ends of the bristle filaments to be brought into a desired shape, that is to say for a desired contour to be imparted to the bristle set on its cleaning side.

The contour of the bristle set can be achieved by way of different overhang lengths of the individual bristle filaments of the bristle set on the front side of the bristle carrier. The profiling apparatus can be configured to produce the different overhang lengths of the bristle filaments by way of an axial shift of the bristle filaments which is oriented in relation to a longitudinal axis of the individual bristle filaments.

In one embodiment of the profiling apparatus, it can have a profiling tool for profiling a cleaning side of the bristle set and/or a counter-profiling tool for profiling a fastening side of the bristle set and/or for supporting the bristle filaments during the profiling.

The profiling tool and the counter-profiling tool can have contours here which are adapted to one another. The profiling tool which acts on a cleaning side of the bristle set can have a negative contour of the contour to be produced of the bristle set. With the aid of the counter-profiling tool, fastening-side ends of the bristle set can be correspondingly supported and/or profiled before fastening of the bristle set to the bristle carrier.

Here, the counter-profiling tool can have the same contour as the bristle set after profiling. The above-explained axial shift of the individual bristle filaments for producing the profiled bristle set can take place in the interaction of the profiling tool with the counter-profiling tool.

Different overhangs of the fastening-side ends of the bristle filaments on the fastening side of the bristle set which are possibly present after the profiling can be equalized during melting of the fastening-side ends of the bristle filaments.

The brush production apparatus can have a filament holder for holding (in particular, in a clamping manner) the bristle filaments of the bristle set. The filament holder can be used, for example, during the profiling of the bristle set before fastening of the bristle set to the bristle carrier, but can also be used to hold the possibly already profiled bristle set during heating and melting of the fastening-side ends of the bristle filaments. The filament holder can still hold the bristle filaments of the bristle set even during the fastening of the bristle filaments in the receiving depression of the bristle carrier, and can be released only after successful fastening of the bristle filaments to the bristle carrier. The filament holder can have a releasable clamping action for holding bristle filaments in a clamping manner.

The filament holder can have a hole pattern of receiving holes for bristle bundles comprising bristle filaments, which hole pattern corresponds to a bundle arrangement of bristle bundles in the bristle set. In this way, the bristle filaments can be provided with the filament holder in their arrangement which is provided for fastening to the bristle carrier and in the bristle set of the brush to be produced. The receiving holes are preferably configured as through holes. The bristle filaments and bristle bundles which are situated in the receiving holes can thus be pushed out of the receiving holes in an axial movement in relation to their longitudinal axes, for example in order to press the fastening-side ends of the bristle filaments into the receiving depression of a bristle carrier and to connect the bristle filaments to the bristle carrier.

The filament holder can be configured, for example, as a cartridge and/or can be capable of being transported between individual stations of the brush production apparatus.

It can be advantageous, furthermore, if the brush production apparatus has a cooling apparatus for cooling bristle carriers, in particular after successful fastening of the bristle filaments to the bristle carrier. With the aid of the cooling apparatus, cooling of the bristle carriers can be accelerated, and the process time during the production of the brushes can thus be reduced.

Furthermore, the bristle production apparatus can have a magazine for receiving a supply of loose bristle filaments. Mounted downstream of the magazine, the bristle production apparatus can comprise a bundle dividing apparatus which is configured to pick bristle bundles from the supply contained in the magazine of loose bristle filaments and to provide them for the assembly of a bristle set.

Furthermore, the brush production apparatus can have a bundle reshaping unit which is configured to transform the bristle bundles which are picked from the bristle magazine into a target shape which is desired for the production of the brushes.

From the bundle reshaping unit, the bristle bundles can be transferred to the abovementioned filament holder. In the filament holder, the bristle bundles can then be held in an arrangement relative to one another which they also later assume in the bristle set of the brush to be produced.

The profiling tool and/or the counter-profiling tool can each be configured as profile plates. The profiling tool can be configured, moreover, to move the bristle filaments which are provided in the filament holder, after melting of their fastening-side ends, with their fastening-side ends into the receiving depression of a provided bristle carrier. It can be advantageous in this context if the profiling tool is mounted movably in order to carry out this movement.

In the case of toothbrushes, the bristle set can have, in particular in a region in which the bristle set is arranged adjacently with respect to an edge of the bristle carrier which delimits the receiving depression, a spacing (which can be measured transversely with respect to the longitudinal extent of the bristle filaments) from a periphery of the bristle carrier of, for example, from 0.5 mm to 3 mm. In the case of large brushes, this spacing can be, for example, from 1 mm to 6 mm. In the case of small brushes, this spacing can be, for example, from 0.2 mm to 1 mm.

In the case of toothbrushes, the melted filament material, that is to say for example the abovementioned carrier plate, can be at a spacing (which can be measured transversely with respect to the longitudinal extent of the bristle filaments) from a periphery of the bristle carrier of from 0.3 mm to 2 mm in a region which is delimited by an edge of the bristle carrier. In the case of large brushes, this spacing can be, for example, from 0.8 mm to 4 mm. In the case of small brushes, this spacing can be, for example, from 0 mm to 0.7 mm.

In the region of a recess in an edge, surrounding the receiving depression, of the bristle carrier, the melted filament material, in particular the abovementioned carrier plate, can be at a spacing (which can be measured transversely with respect to the longitudinal extent of the bristle filaments) from a periphery of the bristle carrier of from 0 mm to 2 mm in the case of toothbrushes. In the case of large brushes, this spacing can be, for example, from 0 mm to 4 mm. In the case of small brushes, this spacing can be, for example, from 0 mm to 1 mm.

After fastening of the bristle filaments to the bristle carrier, the bristle carrier can have, for example, a material thickness of from 2 mm to 6 mm in the case of toothbrushes. In the case of large brushes, the bristle carrier can have, for example, a material thickness of from 3 mm to 10 mm. In the case of small brushes, the bristle carrier can have, for example, a material thickness of from 0.7 mm to 2 mm.

In the case of toothbrushes, before fastening of the bristle filaments to the bristle carrier, the receiving depression can have, for example, a material thickness between 1 mm and 4 mm and, in the case of large brushes, between 1.5 mm and 6 mm and, in the case of small brushes, for example between 0.4 mm and 1.5 mm.

Large brushes within the context of the previous comments can be, for example, hand brushes. Small brushes can be, for example, brushes for carrying out a smear.

### BRIEF DESCRIPTION OF THE DRAWINGS

The invention will be explained in greater detail in the following text on the basis of exemplary embodiments. The invention is not restricted to the exemplary embodiments which are shown in the figures. Further exemplary embodiments of the invention result from combination of the features of individual claims and/or from combination of the features of individual ones or several of the exemplary embodiments which are shown. In the figures:

FIGS. 1 to 4 show different views of a brush which is configured as a toothbrush, wherein it can be seen that a bristle carrier of the brush has a receiving depression for receiving the fastening-side ends of bristle filaments of a bristle set of the brush, which receiving depression is filled with melted filament material after fastening of the bristle filaments to the bristle carrier,

FIG. 5 shows a perspective view of the bristle set of the brush shown in FIGS. 1 to 4 after melting of the fastening-side ends of its bristle filaments,

FIGS. 6 to 9 show different views of a further embodiment of a compatible brush, the receiving depression of which is penetrated by a structure comprising reinforcing ribs for receiving a bristle set,

FIG. 10 shows a perspective view of the bristle set of the brush shown in FIGS. 6 to 9 after melting of the fastening-side ends of its bristle filaments,

FIG. 11 shows a diagrammatic illustration of parts of a brush production apparatus for producing the brushes which are shown in the previous figures, and

FIGS. 12 to 14 show further parts of the brush production apparatus for illustrating a method for producing the brushes shown at least in parts in FIGS. 1 to 10.

### DETAILED DESCRIPTION

In the following description of different embodiments of the invention, elements which coincide with regard to their function are given coinciding designations even in the case of a different shape.

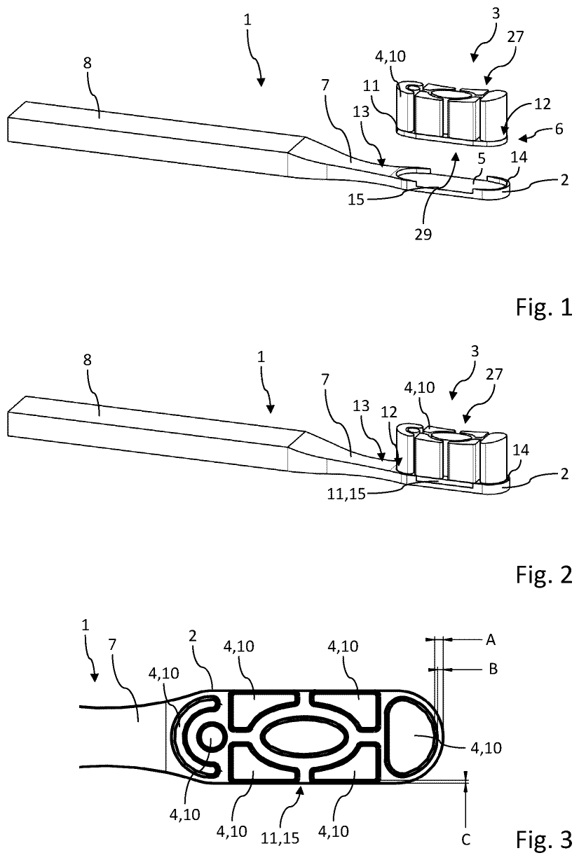

FIGS. 1-5 and 6-10 each show at least parts of a brush denoted overall by 1 which is configured as a toothbrush. Unless explicitly indicated, the following comments refer to both embodiments of the brush 1 which are shown in the figures.

The brush 1 has a bristle carrier 2, namely a brush head, to which a bristle set 3 comprising bristle filaments 4 is fastened.

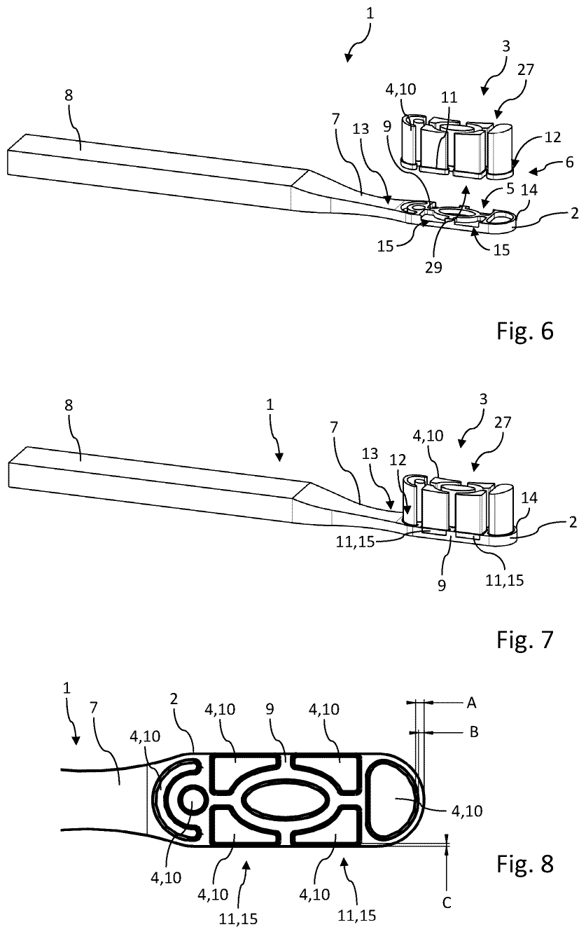

For example, FIGS. 1 and 6 illustrate that the brush 1 has a receiving depression 5 on its bristle carrier 2. Bristle filaments 4 are fastened with their fastening-side ends 6 in the receiving depression 5. The receiving depression 5 is filled completely or preferably predominantly by filament material, melted to fasten the bristle filaments 4, of the fastening-side ends 6 on the finished brush 1. The bristle carrier 2, namely the brush head, is connected via a neck portion 7 of the brush 1 to a handle 8 of the brush 1. FIGS. 1 and 4 show, for example, that the bristle carrier 2 has its lowest material thickness (which can be measured in the direction of a perpendicular with respect to the receiving depression 5) in the region of the receiving depression 5 before fastening of the bristle filaments 4. The bristle carrier 2 is of considerably thicker configuration in adjacent regions. This is shown, for example, by FIGS. 4 and 9, in which the material thickness E in the region of the receiving depression 5 and the material thickness D in adjacent portions of the bristle carrier 2 are illustrated by dimensioning.

The bristle carrier 2 is reinforced by the melted filament material of the bristle filaments 4 after fastening of the bristle filaments 4 to the bristle carrier 2 in the region of its filled receiving depression 5.

In that exemplary embodiment of a brush 1 which is shown in FIGS. 6-10, reinforcing ribs 9 are configured within the receiving depression 5, which impart a satisfactory stability to the bristle carrier 2 despite its comparatively small material thickness E in the region of the receiving depression 5. This can simplify the handling of the bristle carrier 2 during the production of the brush 1.

The receiving depression 5 is segmented by way of the reinforcing ribs 9 which are present within the receiving depression 5. The arrangement of the reinforcing ribs 9 produces a pattern of individual receptacles which corresponds with regard to the shape and arrangement to a cross-sectional shape and arrangement of bristle bundles 11 of the bristle set 3 which comprise the bristle filaments 4.

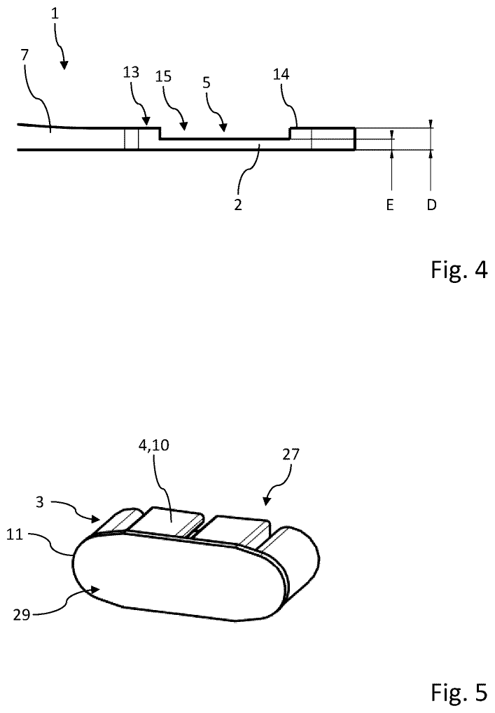

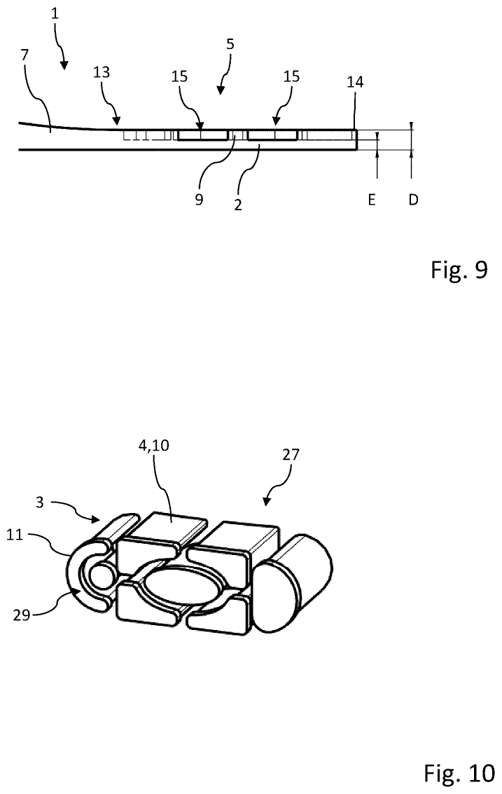

FIGS. 5 and 10 illustrate that the melted filament material of the respectively shown bristle set 3 forms at least one carrier plate 11 which fills the receiving depression 5 of the respective brush 1 after fastening of the bristle filaments 4 to the bristle carrier 2.

By way of the carrier plate 11, the bristle filaments 4 or the bristle bundles 10 which are formed from the bristle filaments 4 can be connected among one another. This is the case, in particular, in the carrier plate 11 which is shown in FIG. 5.

In the bristle set 3, which is shown in FIG. 10, the bristle filaments 4 within a bristle bundle 10 are connected by way of a carrier plate 11. Each of the total of eight bristle bundles 10 therefore has a carrier plate 11.

The carrier plate 11 fills the receiving depression 5 in such a way that a surface 12 of the carrier plate 11 is flush with a brush surface 13, adjoining the receiving depression 5 and the bristle set 3, of the brush 1. In an analogous way, the plurality of carrier plates 11 of the bristle set 3 which is shown in FIG. 10 also fill the parts of the receiving depression 5, segmented by way of the reinforcing ribs 9, of the bristle carrier 2 which is shown in FIGS. 6 to 9. There too, surfaces 12 of the carrier plate 11 are then flush with a brush surface 13, surrounding the receiving depression 5, of the brush 1.

The bristle filaments 4 and the bristle carrier 2, and also the neck portion 7 and the handle 8 of the brush 1, comprise the same material which additionally permits an integrally joined connection between the bristle filaments 4 and the bristle carrier 2.

The brushes 1 which are shown in the figures are therefore what are known as single substance brushes. Since a biodegradable plastic, for example polyamide, namely preferably PA 10.10 or PA 12, is used as material for the production of the bristle carrier 2, the neck portion 7, the handle 8 and the bristle filaments 4 of the bristle set 3 of the brush 1, the brush 1 is particularly environmentally friendly and can be recycled simply.

After their connection, the bristle filaments 4, fastened in the receiving depression 5, and the bristle carrier 2 form a materially homogeneous, monolithic unit and are connected to one another in an integrally joined manner.

The bristle carrier 2 has an edge 14 which laterally delimits the receiving depression 5. The edge 14 serves to guide the melted filament material during the connection of the bristle filaments 4 to the bristle carrier 2 in such a way that the receiving depression 5 is filled completely or preferably predominantly with the melted filament material of the fastening-side ends 6 of the bristle filaments 4.

A plurality of recesses 15 are configured in each case in the edge 14, which recesses 15 are filled by the melted filament material of the fastening-side ends 6 of the bristle filaments 4, preferably in a flush manner with respect to adjacent edge portions. This is illustrated, for example, by FIG. 3 which shows a plan view of the bristle carrier 2, configured as a brush head, of the one brush 1.

It can be seen from this illustration that the recesses 15 in the edge 14 are filled almost completely with the melted filament material of the fastening-side ends 6 of the bristle filaments 4.

FIGS. 3 and 8 show that the bristle set 3 is arranged on the finished toothbrush in a region in which the bristle set 3 is arranged adjacently with respect to that edge 14 of the bristle carrier 2 which delimits the receiving depression 5, and can be, for example, at a spacing A of from 0.5 mm to 3 mm from a periphery of the bristle carrier 2. In this case, the spacing A also defines the spacing of the bristle bundle 10 from the periphery of the bristle carrier 2.

FIGS. 3 and 8 also show that the melted filament material and therefore the carrier plate 11 can be at a spacing B from the periphery of the bristle carrier 2 of, for example, from 0.3 mm to 2 mm where they are surrounded by the edge 14 of the bristle carrier 2. In this case, the spacing B also defines the edge thickness of that edge 14 of the bristle carrier 2 which delimits the receiving depression 5 and bears against the carrier plate 11.

FIGS. 3 and 8 show, furthermore, that the melted filament material and therefore the carrier plate 11 can be at a spacing C from the periphery of the bristle carrier 2 of, for example, from 0 mm to 2 mm in the region of a recess 15 in an edge 14, surrounding the receiving depression 5, of the bristle carrier 2. The melted filament material which forms the carrier plate 11 can therefore reach as far as completely to the outside in the region of a recess 15 in the edge 14, can fill the recess 15 and can form a flush termination with adjacent edge portions.

FIGS. 4 and 9 show that the bristle carrier 2 can have a material thickness D of from 2 mm to 6 mm on the edge side and after fastening of the bristle filaments 4 to the bristle carrier 6. Here, the material thickness D defines the head thickness of the bristle carrier.

FIGS. 4 and 9 show, furthermore, that a material thickness E in the region of the receiving depression 5 before fastening of the bristle filaments 4 to the bristle carrier 2 in the case of toothbrushes can be, for example, from 1 mm to 4 mm. The difference of the dimensions D and E then defines the height of the edge 14 above the receiving depression 5.

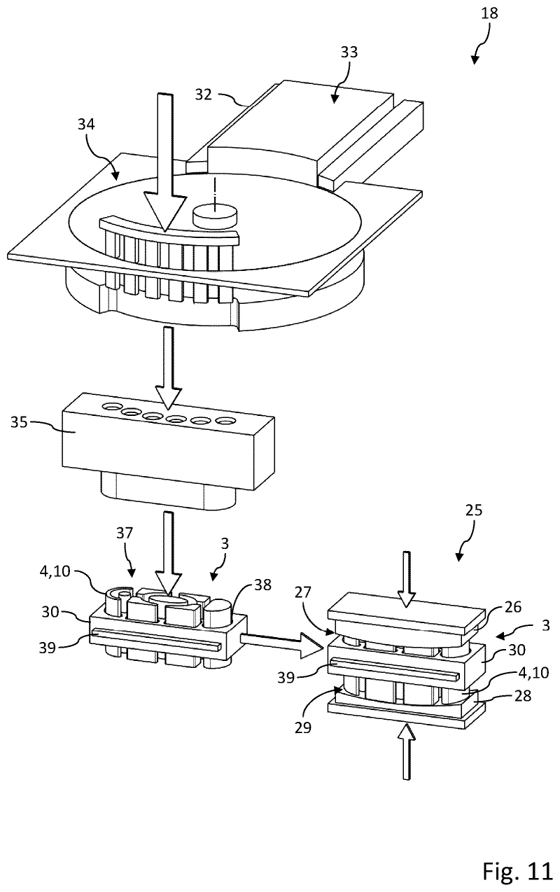

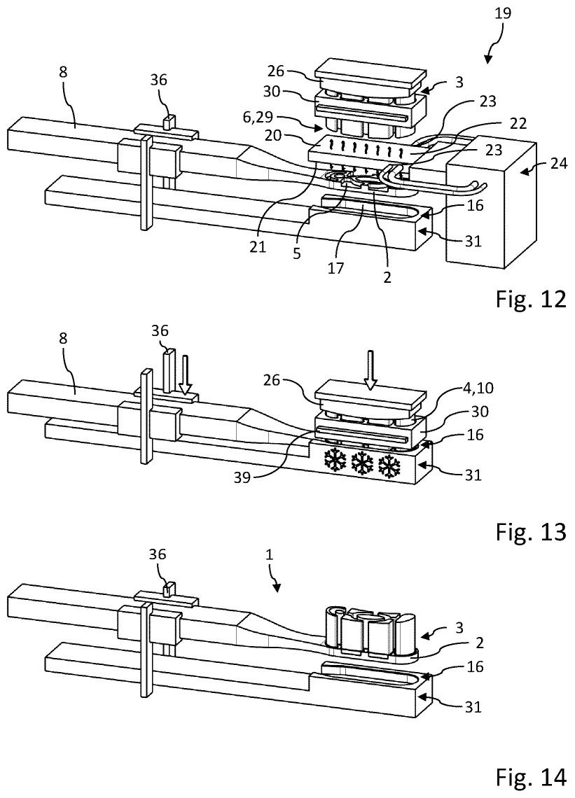

FIGS. 11-14 illustrate a method for producing a brush 1, as shown at least in parts in FIGS. 1-9. FIG. 12 shows that first of all the fastening-side ends 6 of the bristle filaments 4 are heated for the connection of the bristle filaments 4 to the provided bristle carrier 2, and the receiving depression 5 is filled completely or preferably predominantly by filament material, heated in the process, of the fastening-side ends 6 of the bristle filaments 4 during the fastening of the bristle filaments 4 to the bristle carrier 2. FIG. 12 shows, furthermore, that not only the fastening-side ends 6 of the bristle filaments 4, but also the bristle carrier 2 in the region of its receiving depression 5 are heated here in a contactless manner by means of heat radiation.

Here, the fastening-side ends 6 of the bristle filaments 4 are heated to a higher temperature than the bristle carrier 2 in the region of its receiving depression 5. While the fastening-side ends 6 of the bristle filaments 4 are heated to such an extent that they melt, the temperature, to which the bristle carrier 2 is heated in the region of its receiving depression 5, is selected to be lower, with the result that the bristle carrier 2 does not melt in the region of the receiving depression 5. After their fastening to the bristle carrier 2, the bristle filaments 4 and the bristle carrier 2 are connected to one another in an integrally joined manner and form the abovementioned materially homogeneous, monolithic unit.

The recesses 15 which are present in that edge 14 of the bristle carrier 2 which laterally delimits the receiving depression 5 are preferably filled by the filament material of the fastening-side ends 6 of the bristle filaments 4 in a flush manner with respect to adjacent edge portions during the fastening of the bristle filaments 4 to the bristle carrier 2.

The bristle carrier 2 is inserted into a mold 16 in order to fasten the bristle filaments 4 in the receiving depression 5. The mold 16 has a mold wall 17 which laterally surrounds the receiving depression 5 of the bristle carrier 2 in such a way that that edge 14 of the bristle carrier 2 which laterally delimits the receiving depression 5 is supported laterally.

According to FIG. 13, the bristle carrier 2 is inserted into the mold 16 after the fastening-side ends 6 of the bristle filaments 4 and the bristle carrier 2 have been heated. The insertion of the bristle carrier 2 takes place by way of a lifting apparatus 36 of a brush production apparatus 18 which is explained in greater detail in the following text.

After the filling of the receiving depression 5 by the filament material of the fastening-side ends 6 of the bristle filaments 4, the bristle carrier 2 is cooled via the mold 16.

A brush production apparatus which is denoted overall by 18 is used to carry out the method. The brush production apparatus 18 has a heating apparatus 19. The heating apparatus 19 comprises two heating surfaces 20 and 21, of which a first heating surface 20 is provided to heat fastening-side ends 6 of bristle filaments 4 and a second heating surface 21 is provided to heat a bristle carrier 2 in a region of its receiving depression 5. Here, the heating surfaces 20 and 21 emit the heat via heat radiation to the bristle filaments 4 and the bristle carrier 2, respectively.

The heating apparatus 19 is configured to heat the two heating surfaces 20 and 21 and, via them, the fastening-side ends 6 of the bristle filaments and the bristle carrier 2 in the region of its receiving depression 5 to different temperatures. Here, the heating surface 20 can be heated to a temperature which is sufficient to melt the fastening-side ends 6 of the bristle filaments 3 by means of heat radiation.

The two heating surfaces 20 and 21 are arranged on a common heating element 22 and on different sides (namely on sides which face away from one another) of the heating element 22 here.

It is possible in this way to position the heating element 22 in its position shown in FIG. 12 between a provided bristle carrier 2 and provided bristle filaments 4, in order to heat the fastening-side ends 6 of the bristle filaments 4 via the heating surface 20 and to heat the bristle carrier 2 via the heating surface 21.

The heating apparatus 19 is configured for independent control of the temperatures of the two heating surfaces 20 and 21. In order to detect and control the temperatures of the two heating surfaces 20 and 21, the heating apparatus 19 comprises in each case at least one temperature sensor 23 for each of the heating surfaces 20 and 21.

It is possible with the aid of the temperature sensors 23 to detect the temperatures of the heating surfaces 20 and 21 and thus to perform the control of the temperatures of the two heating surfaces 20 and 21 to a target temperature. In order to carry out the temperature control of the heating surfaces 20 and 21, the heating apparatus 19 is equipped with a corresponding control unit 24. The control unit 24 is connected to the temperature sensors 23, and can adapt the temperatures of the heating surfaces 20 and 21 in a manner which is dependent on a deviation, detected by way of the temperature sensors 23, of a respective actual temperature from a setpoint temperature of the heating surfaces 20, 21.

The abovementioned mold 16 is part of the brush production apparatus 18. The mold 16 serves to receive and support the bristle carrier 2 during the fastening of the bristle filaments 4 to the bristle carrier 2. In order to fasten the bristle filaments 4 in the receiving depression after heating of the fastening-side ends 6 of the bristle filaments 4 and the bristle carrier 2, the bristle carrier 2 is lowered into the mold 6 by way of the lifting apparatus 36 of the brush production apparatus 18.

The brush production apparatus 18 also comprises a profiling apparatus 25. The profiling apparatus 25 is shown in FIG. 11 and in parts in FIGS. 12 and 13. The profiling apparatus 25 serves to profile the bristle set 3 of the brush 1 to be produced.

The profiling apparatus 25 has a profiling tool 26 for profiling a cleaning side 27 of the bristle set 3, and a counter-profiling tool 28 for supporting and profiling a fastening side 29 of the bristle set 3.

The method of operation of the profiling apparatus 25 can be seen, for example, from FIG. 11. According to this diagram, the profiling tool 26 is moved with its shaping, convexly formed surface against the cleaning side 27 of the bristle set 3. As a result, the bristle filaments 4 are shifted axially in relation to their longitudinal axis in accordance with the shape of the profiling tool 26. The bristle filaments 4 are supported and shaped by way of the counter-profiling tool 28 which is placed onto the fastening side 29 of the bristle set 3 and the surface of which has a contour which corresponds to the target contour of the bristle set 3 on its cleaning side 27 and is concavely formed.

The different overhang of the bristle filaments 4 on the fastening side 29 of the bristle set 3 is equalized during the melting of the fastening-side ends 6 of the bristle filaments 4 in order to fasten the bristle filaments 4 to the bristle carrier 2 of a brush 1 to be produced.

FIG. 11 shows that the brush production apparatus 18 additionally has a filament holder 30 with a clamping means 39 for holding the bristle filaments 4 of the bristle set 3 in a clamping manner. The filament holder 30 is configured as a cartridge and can be moved from station to station of the brush production apparatus 18 and can hold the bristle filaments 4 during the profiling of the bristle set 3 just as during the heating of the fastening-side ends 6 of the bristle filaments 4 at the heating apparatus 19. The filament holder 30 has a hole pattern 37 of receiving holes 38 for bristle bundles 10 which comprises bristle filaments 4 and corresponds to a bundle arrangement of bristle bundles 10 in the bristle set 3.

The filament holder 30 is also used when the fastening-side ends 6 of the bristle filaments 4 are pressed into the receiving depression 5 of a provided bristle carrier 2. Here, however, its clamping means 39 is open. The bristle filaments 4 can thus be pressed by way of their fastening-side ends 6 into the receiving depression 5 with the aid of the profiling tool 26 which loads the bristle filaments 4 axially on the fastening side 27 of the bristle set 3. Here, the bristle filaments 4 are guided by the filament holder 30 and its continuous receiving holes 38.

In order to cool the bristle carrier 2 after the fastening of the bristle filaments 4 to the bristle carrier 2, the brush production apparatus 18 has, moreover, a cooling apparatus 31. The cooling apparatus 31 is configured to cool the bristle carrier 2 which is arranged in the mold 16.

According to FIG. 11, the brush production apparatus 18 has, moreover, a magazine 32, in which a supply of loose bristle filaments 33 is arranged.

Bristle bundles 10 can be separated from the supply of loose bristle filaments 33 in the magazine 32 with the aid of a dividing apparatus 34 of the brush production apparatus 18. With the aid of a bundle shaping unit 35, the bristle bundles 10 can be brought into their target form which is desired in the bristle set 3 of the brush 1 to be produced.

From the bundle shaping unit 35, the bristle bundles 10 are transferred to the filament holder 30 and are fixed by way of the clamping means 39 in the receiving holes 38 which are configured as through holes.

FIG. 14 shows how the finished brush 1 is lifted from the mold 16 by way of the lifting apparatus 36 after cooling of the bristle carrier 2. The bristle set 3 is then connected to the bristle carrier 2 of the brush 1.

The invention is concerned with improvements in the technical field of brush production and relates, inter alia, to a brush 1 which has a bristle carrier 2 with a receiving depression 5 which, during the fastening of bristle filaments 4 to the bristle carrier 2, is filled completely or partially by melted filament material of fastening-side ends 6 of the bristle filaments 4 of the brush 1 to be produced.

### LIST OF DESIGNATIONS

1 Brush
2 Bristle carrier, brush head
3 Bristle set
4 Bristle filaments
5 Receiving depression
6 Fastening-side ends of 4
7 Neck portion
8 Handle
9 Reinforcing rib
10 Bristle bundle
11 Carrier plate
12 Surface of 11
13 Brush surface
14 Edge
15 Recess in 15
16 Mold
17 Mold wall
18 Brush production apparatus
19 Heating apparatus
20 Heating surface for 6
21 Heating surface for 2
22 Heating element
23 Temperature sensor
24 Control unit
25 Profiling apparatus
26 Profiling tool
27 Cleaning side
28 Counter-profiling tool
29 Fastening side
30 Filament holder
31 Cooling apparatus
32 Magazine
33 Supply of loose bristle filaments
34 Dividing apparatus
35 Bundle shaping unit
36 Lifting apparatus
37 Hole pattern of 30
38 Receiving hole in 30
39 Clamping means of 30

1. A brush (1), comprising:
a bristle carrier (2);
a bristle set (3) comprising bristle filaments (4), wherein the bristle carrier (2) has at least one receiving depression (5), in which the bristle filaments (4) are fastened by fastening-side ends (6) thereof; and
the at least one receiving depression (5) is filled completely or partially by melted filament material of the fastening-side ends (6) to fasten the bristle filaments (4).

2. The brush (1) as claimed in claim wherein at least one of, a) before fastening of the bristle filaments (4), the bristle carrier (2) has a smallest material thickness in a region of the receiving depression (5), or b) the bristle carrier (2) is reinforced by the melted filament material.

3. The brush (1) as claimed in claim 1, further comprising at least one reinforcing rib (9) configured within the receiving depression (5).

4. The brush (1) as claimed in claim 1, wherein at least one of a) the melted filament material forms a carrier plate (11) which fills the receiving depression (5), or b) a surface (12) of the carrier plate is flush with respect to a brush surface (13), adjoining the receiving depression (5) and the bristle set (3), of the brush (1).

5. The brush (1) as claimed in claim 1, wherein at least one of a) the bristle filaments (4) and the bristle carrier (2) comprise, at least in a region of the receiving depression (5), materials which are compatible for an integrally joined connection or a same material which is suitable for an integrally joined connection, or b) the bristle filaments (4) which are fastened in the receiving depression (5) and the bristle carrier (2) form at least one of a materially homogeneous, monolithic unit or are connected to one another in an integrally joined manner.

6. The brush (1) as claimed in claim 1, wherein the bristle filaments (4) and the bristle carrier (2) comprise, at least in a region of the receiving depression (5), plastic.

7. The brush (1) as claimed in claim 1, claims, wherein the bristle carrier (2) has an edge (14) which delimits the receiving depression (5) transversely with respect to a longitudinal extent of the bristle filaments (4).

8. The brush (1) as claimed in claim 7, wherein at least one recess (15) is configured in the edge (14), and said recess is filled completely or partially by the melted filament material.

9. A method for producing a brush (1) as claimed in claim 1, the method comprising:
heating the fastening-side ends (6) of the bristle filaments (4) in order to connect the bristle filaments (4) to the bristle carrier (2); and
filling the receiving depression (5) completely or partially by the melted filament material of the fastening-side ends (6) during fastening of the bristle filaments (4) to the bristle carrier (2).

10. The method as claimed in claim 9, wherein the fastening-side ends (6) of the bristle filaments (4) and the bristle carrier (2) are heated in a region of the receiving depression (5).

11. The method as claimed in claim 9, wherein the fastening-side ends (6) of the bristle filaments (4) are heated to a higher temperature than the bristle carrier (2) in a region of the receiving depression (5).

12. The method as claimed in claim 9, further comprising connecting the bristle filaments (4) and the bristle carrier (2) to one another in an integrally joined manner.

13. The method as claimed in claim 9, further comprising filling at least one recess (15) which is present in an edge (14) which laterally delimits the receiving depression (5) by the filament material of the fastening-side ends (6).

14. The method as claimed in claim 9, further comprising inserting the bristle carrier (2) into a mold (16) which has a mold wall (17) which surrounds the receiving depression (5) of the bristle carrier (2) laterally at least in sections in order to fasten the bristle filaments (4) in the receiving depression (2).

15. The method as claimed in claim 14, further comprising, after filling of the receiving depression (5) by the melted filament material of the fastening-side ends (6), cooling the bristle carrier (2) via the mold (16).

16. A brush production apparatus (18) for producing brushes (1) as claimed in claim 1, the brush production apparatus (18) comprising:
a heating apparatus (19) which comprises first and second heating surfaces (20, 21), the first heating surface (20) is provided to heat the fastening-side ends (6) of the bristle filaments (4) and the second heating surface (21) is provided to heat the bristle carrier (2) in a region of the receiving depression (5).

17. The brush production apparatus (18) as claimed in claim 16, wherein at least one of a) the heating apparatus (19) is configured to heat the heating surfaces (20, 21) to different temperatures, b) the heating apparatus (19) is configured to heat the first heating surface (20) to a temperature which is sufficient to melt the fastening-side ends (6) of the bristle filaments (4), or c) the two heating surfaces (20, 21) are arranged on a common heating element (22).

18. The brush production apparatus (18) as claimed in claim 16, wherein the heating apparatus (19) is configured for control of temperatures of the first and second heating surfaces (20, 21), and includes a control unit (24) and at least one temperature sensor (23) for detecting and controlling the temperature of at least one of the first or second heating surfaces (20, 21).

19. The brush production apparatus (18) as claimed in claim 16, further comprising a mold (16) for receiving and supporting the bristle carrier (2).

20. The brush production apparatus (18) as claimed in claim 16, further comprising a profiling apparatus (25) for profiling a bristle set (3) of a brush (1) to be produced.

21. The brush production apparatus (18) as claimed in claim 20, wherein the profiling apparatus (25) has at least one of a profiling tool (26) for profiling a cleaning side (27) of the bristle set (3) or a counter-profiling tool (28) for at least one of profiling a fastening side (29) of the bristle set (3) or for supporting the bristle filaments (4) during the profiling of the bristle set (3).

22. The brush production apparatus (18) as claimed in claim 16, further comprising at least one of a) a filament holder (30) for holding the bristle filaments (4) of the bristle set (3), or b) a cooling apparatus (31) for cooling the bristle carrier (2).
